(19) United States
(12) Patent Application Publication
(10) Pub. No.: US 2007/0070894 A1
(43) Pub. Date: Mar. 29, 2007

(54) Method to determine a scheduling priority value for a user data connection based on a quality of service requirement

(76) Inventors: Fan Wang, Chicago, IL (US); Amitava Ghosh, Buffalo Grove, IL (US); Rapeepat Ratasuk, Hoffman Estates, IL (US); Nick W. Whinnett, Marlborough (GB); Weimin Xiao, Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/235,625

(22) Filed: Sep. 26, 2005

(51) Int. Cl. H04L 12/26

(52) U.S. Cl. 370/230

(57) ABSTRACT

A method to provide a nominal best effort data rate based on a Quality of Service (QoS) requirement of a user data connection, the method comprising assigning (105) a service priority based on the QoS requirement, and assigning (110) the nominal best effort data rate for the service priority using a predetermined function. Further, it comprises of a method to determine a scheduling priority value for a user data connection by providing a relative fairness. Furthermore, the method comprises a method to satisfy a delay requirement for a delay sensitive data connection through a scheduling.

### FIELD OF INVENTION

The invention relates generally to scheduling algorithms for wireless communications. More specifically, the invention relates to a method to determine a scheduling priority for a user data connection based on a Quality of Service (QoS) requirement.

### BACKGROUND OF THE INVENTION

In case of high-speed data transmission, scheduling improves utilization of the link and reduces transmission delays. Existing schedulers implement the allocation and utilization of resources based on a priority, the priority being calculated by considering factors such as an average data rate and a channel characteristic. As for example, in a High Speed Downlink Packet Access (HSDPA) system, the scheduler allocates resources to the HSDPA users based on a channel condition reported by a mobile by means of Channel Quality Indicator (CQI) signaling.

A widely used scheduling algorithm is a proportional fair scheduler algorithm that adaptively schedules users for transmission according to channel fading processes. The proportional fair scheduler algorithm has been applied in Code Division Multiple Access (CDMA) standard such as 1xEV-DO (1x Evolution Data Only) and 1xEV-DV (1x Evolution Data and Voice). As compared to other fairness criteria algorithms, such as the conventional max-min fairness, the proportional fair scheduling provides fairness amongst users by favoring users with lower throughput. However, it doesn't provide relative fairness between different data traffics based on the assigned priority.

Further, the existing scheduler algorithms do not consider Quality of Service (QoS) characteristics of different services.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a flowchart that depicts the steps to provide a nominal best effort data rate based on a Quality of Service (QoS) requirement of a user data connection in accordance with an embodiment of the invention.

FIG. 2 is a flowsheet that depicts the steps to determine a scheduling priority for a user data connection to achieve a relative fairness criterion in accordance with an embodiment of the invention.

FIG. 3 is a flowsheet that depicts the steps in order to apply a weight for nominal best effort data to a scheduling priority value in accordance with an embodiment of the invention.

FIG. 4 is a flowsheet that depicts the steps in order to apply a weight for a delay sensitive user data connection to a scheduling priority value in accordance with a discard timer setting as per an embodiment of the invention.

FIG. 5 is a flowsheet that depicts the steps to satisfy a delay requirement for a delay sensitive data connection through a scheduling in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail the method to determine a scheduling priority for a user data connection based on a Quality of Service (QoS) requirement in accordance with the invention, it should be observed that the invention resides primarily in combinations of method steps and apparatus components related to the method to determine a scheduling priority for a user data connection based on a QoS requirement. Accordingly, the apparatus components and method steps have been represented where appropriate by conventional symbols in the drawings, showing only those specific details that are pertinent to understanding the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that the method to determine a scheduling priority for a user data connection based on a QoS requirement described herein may be comprised of one or more conventional processors and unique stored program instructions that control the one or more processors to implement, in conjunction with certain non-processor circuits, some, most, or all of the functions of the method to determine a scheduling priority for a user data connection based on a QoS requirement described herein. The non-processor circuits may include, but are not limited to, a radio receiver, a radio transmitter, signal drivers, clock circuits, power source circuits, and user input devices. As such, these functions may be interpreted as steps of a method to determine a scheduling priority for a user data connection based on a QoS requirement. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The proportional fair scheduler, as explained earlier, belongs to a class of a normalized Carrier/Interference (C/I) scheduler. Various services, such as web browsing, File Transfer Protocol (FTP), and Voice over Internet Protocol (VoIP) provided by 3G wireless communications networks have different QoS requirements and require different data service rates. However, the widely used proportional fair scheduling algorithm does not consider the QoS characteristics of different services. The invention deals with a relatively fair scheduler that satisfies QoS requirements of different priority users. For each user, the service provider can determine a service priority level, and a nominal best effort data rate, in accordance with the different service priority level. The service priority level can be associated with a user by way of a service level agreement. For users with same priority level, the fairness among them can be interpreted the same as the proportional fair scheduling algorithm. For users with different priorities, a relative fairness criterion can be applied.

Therefore as compared to existing scheduling systems that provide a service priority considering only factors of average data rate or channel characteristics, the invention provides the service priority by considering overall parameters in relation to a QoS requirement, that include a user service priority (for example a promised bit rate), a packet delay, an achieved average data rate, a channel characteristic and other relevant factors.

Referring now to FIG. 1 that depicts a flowchart 100 of the steps to provide a nominal best effort data rate based on a QoS requirement of a user data connection in accordance with an embodiment of the invention. At step 105, a service priority is assigned to the user data connection based on the QoS requirement of the user data connection. The service priority can take a range of values based on an agreement entered into between the service provider and the owner of the user station. The user station can avail a plurality of services simultaneously and can therefore have a data connection for each of the plurality of services. Therefore, there can be a service priority assigned to each user data connection i.e. a service priority assigned for each of the services available to the user station. Using the service priority assigned to the user data connection, the nominal best effort data rate can be assigned to a user data connection using a predetermined function, as depicted in step 110.

The predetermined function can comprise a monotonically increasing function, where a higher service priority corresponds to a higher nominal best effort data rate. On the other hand, the nominal best effort data rate can have a minimum value corresponding to a minimum service priority. In an embodiment of the invention, the minimum value can correspond to a value obtained by calculating nominal best effort data rate using the predetermined function when the service priority may be assigned a value of zero. The minimum value so obtained from the predetermined function can be based on a plurality of criteria. The plurality of criteria can comprise a type of service, including one of an audio service, video service and data service.

In an embodiment of the invention, the nominal best effort data rate (Γᵢ) may be assigned using a mathematical function as depicted in EQU 1.
Γᵢ=k*(1+pri/C) EQU 1
where, “pri” denotes a service priority that is assigned based on QoS requirements of a user data connection; co-efficient “k” can denote the minimum value corresponding to a minimum service priority; and co-efficient “C” is a constant. The value of C is chosen such that each priority corresponds to a target service data rate or a nominal best effort data rate. For example, in case of High Speed Downlink Packet Access (HSDPA) system (there are 15 priorities), C is equal to 5.

As discussed earlier, the invention relates generally to a relatively fair scheduler that satisfies a QoS requirement of a user data connection. A service priority level can be assigned to a user data connection. For example, in an embodiment of the invention, sixteen levels of priorities can be assigned to a plurality of HS-DSCH (High Speed Downlink Channel) data frames in a HSDPA (High Speed Downlink Packet Access) system, wherein a level of fifteen is a highest priority level, and level of zero is a lowest priority level. A nominal best effort data rate, which can be determined by the service provider in service level agreement (SLA), can be assigned to each service priority level. In case of a plurality of user data connections having the same priority level, fairness among the plurality of user data connections can be interpreted as in a proportional fairness scheduling. However, for a plurality of user data connections with different priorities, a relative fairness can be interpreted as achieving a percentage of a first set of user data connections with a first priority that have failed to attain a corresponding first nominal best effort data rate, same as a percentage of a second set of user data connections with a second priority that have failed to attain a corresponding second nominal best effort data rate. For example, a first set of user data connections have subscribed for 100 Kbps nominal best effort data rate and a second set of user data connections have subscribed for 10 Kbps nominal best effort data rate. As a result, the first set of user data connections have a higher priority than the second set of user data connections. In this example, relative fairness can be interpreted as the percentage of the first set of user data connections that have failed to attain 100 Kbps nominal best effort data rate is equal to the percentage of the second set of user data connections that have failed to attain 10 Kbps nominal best effort data rate.

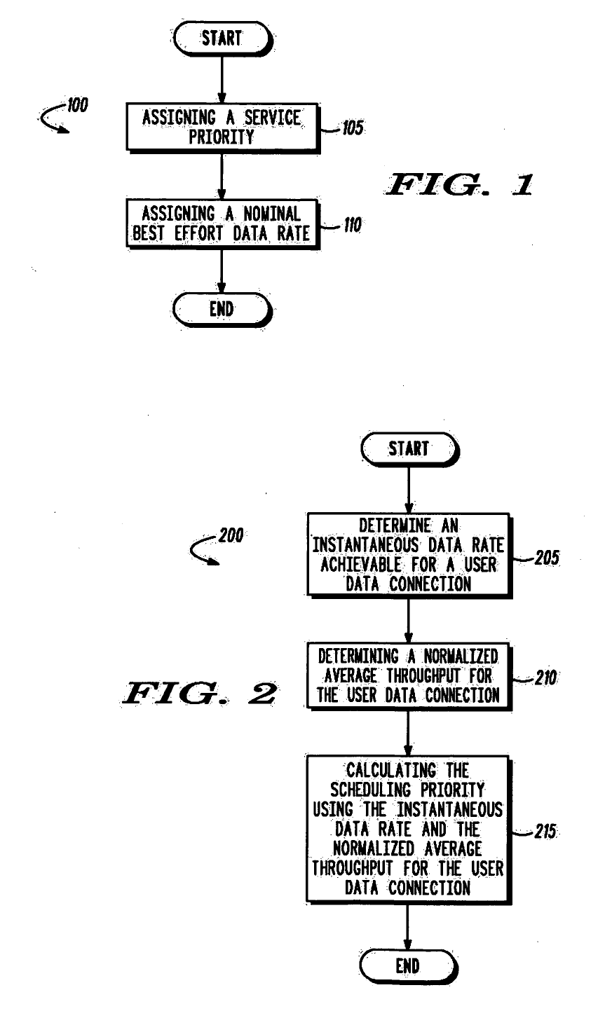

Referring now to FIG. 2, flowsheet 200 depicts the steps to determine a scheduling priority for a user data connection to achieve a relative fairness criterion in accordance with an embodiment of the invention. At step 205, an instantaneous data rate that can be achieved for the user data connection based on a channel quality can be determined. Further, as depicted in step 210, a normalized average throughput for the user data connection can be determined. In an embodiment of the invention comprising non-streaming users, the normalized average throughput can be calculated as a first ratio of an average throughput of the user data connection, with respect to a nominal best effort data rate assigned to the user data connection. In another embodiment of the invention comprising streaming users, the nominal best effort data rate can be a guaranteed bit rate (GBR) received over a NBAP (Node B Application Part). As a result of normalization, the normalized average throughput served to the user data connection reflects a QoS perceived by the user data connection by comparing an actually received service with a provider promised service.

Further as depicted in step 215, the scheduling priority can be calculated as a second ratio of the instantaneous data rate controlled by a first mathematical index, with the normalized average throughput controlled by a second mathematical index. The first mathematical index and the second mathematical index used to control a scheduling fairness can be a power function. The first mathematical index and the second mathematical index can be varied to select a scheduling method between the two extremes of a round robin scheduling and a maximum C/I (Carrier to Interference) scheduling.

In an embodiment of the invention, the scheduling priority value may be computed using a mathematical function as depicted in EQU 2.

$${r}_{i} [ n ] = \frac{{( {DRR}_{i} [ n ] )}^{α}}{{( {\hat{T}}_{i} [ n ] )}^{β}} \qquad EQU 2$$

where, “rᵢ[n]” denotes the scheduling priority value for a i^{th} user data connection up to time “n”. A plurality of resources, such as power and codes can be allocated to the i^{th} user data connection according to the scheduling priority. \hat{T}ᵢ[n] can be the normalized average throughput for the i^{th} user data connection. Normalized average throughput generally refers to a ratio of absolute average throughput of a user (Tᵢ[n]) and the nominal best effort data rate (Γᵢ). DRRᵢ[n] can be the prediction of instantaneous data rate of the i^{th} user data connection and is an indication of a channel characteristic. A first mathematical index “α” and a second mathematical index “β” can be used to control a scheduling fairness. The two parameters “α” and “β” can be varied to select a scheduling method between the two extremes of round robin scheduling (α=0, β=1) and maximum C/I scheduling (α=1, β=0). As a result, round robin scheduling is inversely of \hat{T}ᵢ[n] and maximum C/I scheduling is equal to DRRᵢ[n].

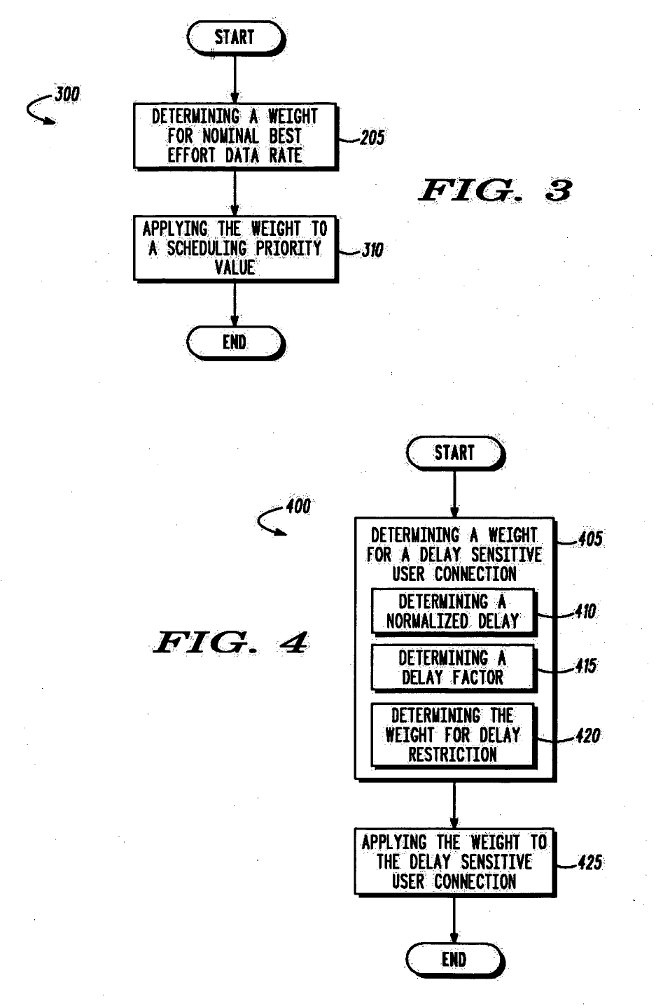

Referring now to FIG. 3, which is a flowsheet 300 that depicts the steps in order to apply a weight for nominal best effort data to a scheduling priority value in accordance with an embodiment of the invention. At step 305, the weight for nominal best effort data rate for a user data connection can be determined using a first mathematical function. The first mathematical function can accept a first pair of inputs comprising a best effort factor and a normalized average throughput. In an embodiment of the invention, the first mathematical function is a smooth function and increases sharply when the data rate in large. Further, the weight for the nominal best effort data rate is higher for a user data that has a data rate closer to the target rate. In an exemplary embodiment of the invention, the first mathematical function comprises an exponentiation function. This is further explained in conjunction with EQU 3. As depicted in step 310, the weight for nominal best effort data rate can be applied to the scheduling priority value. The best effort factor is a factor that can be adjusted to change a percentage of user data connections that fail to reach a nominal best effort data rate. In case the value of the best effort factor is set to zero for the user data connection, there is no additional credit added to the user data connection if it fails to reach the nominal best effort data rate. By increasing the best effort factor, the percentage of user data connections that fail to reach the nominal best effort data rate can be reduced. Therefore, by setting a best effort factor to a same value for a plurality of user data connections, wherein each of the user data connections may be assigned a different priority, the percentage of user data connections that fail to reach the nominal best effort data rate in each different priority would be the same. As a result, a relative fairness requirement is satisfied.

In the embodiment of the invention depicted by EQU 2, a weight for nominal best effort data rate for a user data connection can be determined using an exponentiation function as depicted in EQU 3 where γ_{GBR,i}is a best effort factor and \hat{T}ᵢ[n] is a normalized average throughput.
λ_{GBR,i}[n]=e^{γ}^{_{GBR,i}}^{[1-\hat{T}}^{ᵢ}^{[n]]} EQU 3
In the embodiment depicted in EQU 2, in order to achieve relative fairness the weight for nominal best effort data rate for a user data connection can be applied to the scheduling priority value as depicted in EQU 4.

$${r}_{i} [ n ] = {λ}_{GBR , i} [ n ] \frac{{( {DRR}_{i} [ n ] )}^{α}}{{( {\hat{T}}_{i} [ n ] )}^{β}} \qquad EQU 4$$

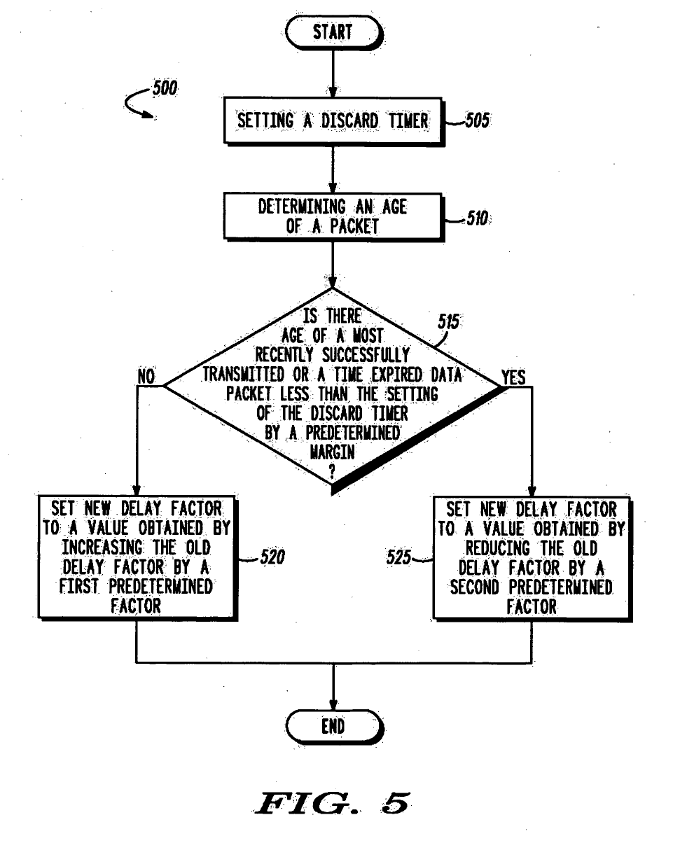

Referring now to FIG. 4, which is a flowsheet 400 that depicts the steps in order to apply a weight for a delay sensitive user data connection to a scheduling priority value in accordance with a discard timer setting as per an embodiment of the invention. Discard timer is generally used for delay sensitive service. If a packet is outdated, it is then dropped.

As depicted in step 405, the step of computing the weight for a delay sensitive user data connection comprises, as in step 410, determining a normalized delay. Normalized delay generally refers to a ratio of a packet delay with the discard timer setting, wherein the packet delay can be an age in time units of the packet being inputted in a priority queue. This is further explained in conjunction with EQU 6.

Thereafter, as depicted in step 415, a delay factor can be determined using a second mathematical function based on a previous delay factor calculated for a previous packet of the delay sensitive user data connection.

In an embodiment of the invention, the second mathematical function comprises maximum and minimum functions as explained later. Further, as depicted in step 420, the weight for the delay restriction for the delay sensitive user data connection can be calculated using a third mathematical function. The third mathematical function can accept a second pair of inputs comprising the normalized delay and the delay factor. In an embodiment of the invention, the third mathematical function is a smooth function and increases sharply when the data rate in large. Further, the weight for the delay restriction is higher for a delay sensitive user data connection that has a delay closer to the target delay. In an exemplary embodiment of the invention, the third mathematical function comprises an exponentiation function. The weight for the delay sensitive user data connection can be applied to the scheduling priority value as depicted in step 425.

In an embodiment of the invention, a weight for a delay restriction for a delay sensitive user data connection may be computed using a mathematical function as depicted in EQU 5.
λ_{de-jitter,i}[n]=e^{γ}^{_{de-jitter,i}}⁽n)[1−\hat{D}^{ᵢ}^{[n]]} EQU 5
In the embodiment depicted above, “λ_{de-jitter,i}” is the weight for delay restriction in case a discard time is defined for the i^{th} user data connection. The delay restriction is determined by a de-jitter buffer size. In case the discard time is set for “Φᵢ” seconds, a normalized delay “\hat{D}ᵢ(n)” can be computed as in EQU 6.
\hat{D}ᵢ(n)=Dᵢ(n)/Φᵢ EQU 6
“Dᵢ(n)” is a packet delay of packets waiting to be transmitted, where the packet delay is an age in seconds of a packet being waiting to be transmitted in a priority queue. The delay factor “γ_{de-jitter,i}” can be a fixed value. Alternatively, the delay factor “γ_{de-jitter,i}” is updated for every packet transmission and is continually increased or decreased to adjust the delay of the packet, taking care that the delay is not beyond an acceptable value for the packet. The weight for the delay restriction can be applied to the embodiment depicted in EQU 4 as shown in EQU 7.

$${r}_{i} [ n ] = {λ}_{GBR , i} [ n ] {λ}_{de - jitter , i} [ n ] \frac{{( {DRR}_{i} [ n ] )}^{α}}{{( {\hat{T}}_{i} [ n ] )}^{β}} \qquad EQU 7$$

Referring now to FIG. 5, which is a flowsheet 500 depicting the steps to satisfy a delay requirement for a delay sensitive data connection through a scheduling in accordance with an embodiment of the invention. As depicted in step 505, a discard timer “Φᵢ” can be set for the delay sensitive data connection. The discard timer “Φᵢ” can be set in time units. Thereafter, step 510, involves determining an age of a packet corresponding to the delay sensitive service in a priority queue of data service. Further, in step 515, a comparison can be performed between the age of a most recently successfully transmitted or time expired data packet with the discard timer setting to determine whether the age of the compared packet is less than the discard timer setting by a predetermined margin. Thereafter, a new delay factor can be calculated for the delay sensitive data connection based on the comparison and an old delay factor of the delay sensitive data connection. As shown in step 520, the new delay factor can be set to a value obtained by increasing the old delay factor by a first predetermined factor, if the age of the most recently successfully transmitted or time expired data packet is not less than the discard timer setting by the predetermined margin. The value can be limited to a ceiling value. In case the age of the oldest packet is not less than the discard timer by a predetermined margin the oldest packet may be dropped. On the other hand, as in step 525, the new delay factor can be set to value obtained by reducing the old delay factor by a second predetermined factor, if the age of the most recently successfully transmitted data packet is less than the discard timer setting by the predetermined margin. In such a case, the value can be limited to a floor value. The delay sensitive data connection can be initialized to a predetermined initial value for a delay factor.

Referring to the embodiment mentioned above, the setting of the new delay factor can be represented by the function as depicted in EQU 8, which further depicts an embodiment to satisfy a delay requirement for a delay sensitive data connection through a scheduling.
γ_{de-jitter,i}(m)=max(γ_{de-jitter,i}(m−1)/2,0.01) if Dᵢ[n]≦0.8Φᵢ
min(γ_{de-jitter,i}(m−1)*2,1) otherwise EQU 8
Therefore as explained above, the new delay factor “γ_{de-jitter,i}(m)” is calculated based on the age of the most recently successfully transmitted or time expired data packet and the old value of delay factor “γ_{de-jitter,i}(m−1)”. The new delay factor can be increased subject to a ceiling value of 1 and can be reduced to a floor value of 0.01. A safety factor can be incorporated in the equation and the comparison can be between Dᵢ[n] and 0.8 Φᵢ.

Further, a weight for the delay sensitive data connection based on the new delay factor can be computed and the weight for the delay sensitive data connection may be applied to a scheduling priority value calculated for the packet in a priority queue during the scheduling in order to obtain a resultant scheduling priority value. Thereafter, allocating of a plurality of resources to the delay sensitive data connections can be based on the resultant scheduling priority values.

Therefore, in the embodiment depicted in EQU 8, if the delay Dᵢ[n] is much less than the discard timer setting “Φᵢ” the new delay factor is reduced, subject to a floor value of 0.01. As a result, in accordance with EQU 7, the weight for delay restriction “λ_{de-jitter},i” would have a reduced value, thereby reducing its scheduling priority “rᵢ[n]”. On the other hand, in case the delay Dᵢ[n] is more than the discard timer setting “Φᵢ”, the new delay factor is increased, subject to a ceiling value of 1.0. As a result, in accordance with EQU 7, the weight for delay restriction “λ_{de-jitter,i}” would have a increased value, thereby increasing its scheduling priority “rᵢ[n]”.

In the foregoing specification, the invention and its benefits and advantages have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method to provide a nominal best effort data rate based on a Quality of Service (QoS) requirement of a user data connection, the method comprising:
assigning a service priority based on the QoS requirement; and
assigning the nominal best effort data rate for the service priority using a predetermined function.

2. The method of claim 1, wherein the predetermined function comprises a monotonically increasing function, where a higher service priority corresponds to a higher nominal best effort data rate.

3. The method of claim 2, wherein the nominal best effort data rate has a minimum value corresponding to a minimum service priority, the minimum value based on a plurality of criteria.

4. The method of claim 3, wherein the plurality of criteria comprises a type of service, the type of service further comprising one of an audio service, video service and data service.

5. A method to determine a scheduling priority value for a user data connection, the method comprising:
determining an instantaneous data rate achievable for the user data connection based on a channel quality;
determining a normalized average throughput for the user data connection, the normalized average throughput being a first ratio of an average throughput of the user data connection, with respect to a nominal best effort data rate assigned to the user data connection;
calculating the scheduling priority value being a second ratio of the instantaneous data rate controlled by a first mathematical index, with the normalized average throughput controlled by a second mathematical index, the first mathematical index and the second mathematical index being used to control a scheduling fairness.

6. The method of claim 5, wherein the calculating step further comprises:
determining a weight for nominal best effort data rate for the user data connection using a first mathematical function, the first mathematical function accepting a first pair of inputs comprising a best effort factor which controls the percentage of user data connections that fail to reach a nominal best effort data rate and the normalized average throughput; and
applying the weight for nominal best effort data rate to the relative fairness factor to the scheduling priority value.

7. The method of claim 6, wherein the first mathematical function comprises an exponentiation function.

8. The method of claim 5 further comprising:
computing a weight for a delay sensitive user data connection in accordance with a discard timer setting; and
applying the weight for the delay sensitive user data connection to the priority value.

9. The method of claim 8, wherein the computing step further comprises:
determining a normalized delay being a third ratio of a packet delay with the discard timer setting, the packet delay being an age in time units of a packet in a priority queue;
determining a delay factor using a second mathematical function based on a previous delay factor calculated for a previously transmitted packet of the delay sensitive user data connection; and
calculating the weight for the delay restriction for the user delay sensitive data connection using a third mathematical function, the third mathematical function accepting a second pair of inputs comprising the normalized delay and the delay factor;

10. The method of claim 9, wherein the second mathematical function comprises maximum and minimum functions.

11. The method of claim 9, wherein the third mathematical function comprises an exponentiation function.

12. The method of claim 5 further comprising allocating a plurality of resources based on the priority value.

13. A method to satisfy a delay requirement for a delay sensitive data connection through a scheduling, the method comprising:
setting a discard timer for the delay sensitive data connection;
determining an age of a packet corresponding to the delay sensitive service in a priority queue;
performing a comparison between the age of a most recently successfully transmitted or time expired data packet with the discard timer setting, to determine whether the age of the compared packet is less than the discard timer setting by a predetermined margin; and
calculating a new delay factor for the delay sensitive data connection based on the comparison and an old delay factor of the delay sensitive data connection.

14. The method of claim 13, wherein the calculating step further comprises:
setting the new delay factor to a value obtained by increasing the old delay factor by a first predetermined factor, if the age of the most recently successfully transmitted or time expired data packet is not less than the discard timer setting by the predetermined margin, the value being limited to a ceiling value.

15. The method of claim 13 further comprising dropping the oldest packet if the age of the oldest packet is not less than the discard timer by a predetermined margin.

16. The method of claim 13, wherein the calculating step further comprises:
setting the new delay factor to value obtained by reducing the old delay factor by a second predetermined factor, if the age of the most recently successfully transmitted data packet is less than the discard timer setting by the predetermined margin, the value being limited to a floor value.

17. The method of claim 13 further comprising assigning a predetermined initial value for a delay factor when a delay sensitive data connection is initialized.

18. The method of claim 13 further comprising computing a weight for a delay sensitive data connection based on the delay factor.

19. The method of claim 18 further comprising applying the weight for the delay sensitive data connection to a scheduling priority value calculated for the a packet in a priority queue during the scheduling, to obtain a resultant scheduling priority value.

20. The method of claim 19 further comprising allocating a plurality of resources to the delay sensitive data connections during the scheduling based on the resultant scheduling priority values.
